(19) United States
(12) Patent Application Publication
(10) Pub. No.: US 2019/0266926 A1
(43) Pub. Date: Aug. 29, 2019

(54) BlueflagProtection Automatic LED Display Dampened Foot Released Sign Pole Systems

(71) Applicant: Arthur Robert Ycedo, Rancho Belago, CA (US)

(72) Inventor: Arthur Robert Ycedo, Rancho Belago, CA (US)

(21) Appl. No.: 15/613,208

(22) Filed: Feb. 23, 2018

(51) Int. Cl. G09F 7/22; F21V 23/04; F21S 9/03; F21V 15/01; F21S 8/08; G08G 1/09; G09F 13/00; B61L 5/18; B61L 5/12

(52) U.S. Cl. CPC G09F 7/22; F21V 23/0464; F21S 9/032; F21V 15/01; F21Y 2115/10; G08G 1/09; G09F 13/005; B61L 5/189; B61L 5/125; F21S 8/08

(57) ABSTRACT

The sign pole system disclosed simplifies the FRA requirement by incorporating many features into the sign pole system. The worker operating the pole can quickly raise the pole just by stepping on the lift bar. To lower the pole ‘remove the required safety’ is done by stepping on the release footstep. The built in LED features will activate only when it is nighttime and when the pole is in the vertical position. The sensitivity to actuate the LED's is adjustable to compensate for night yard overhead lighting. A solar panel keeps the battery charged. When required a pad lock (lock out device) can be inserted into the foot step base to secure the sign pole system in the up position until deemed safe by the worker to remove the sign protection. Manually attaching a night time blue light is no longer required because the LED light is now built into the sign pole and is automatically actuated.

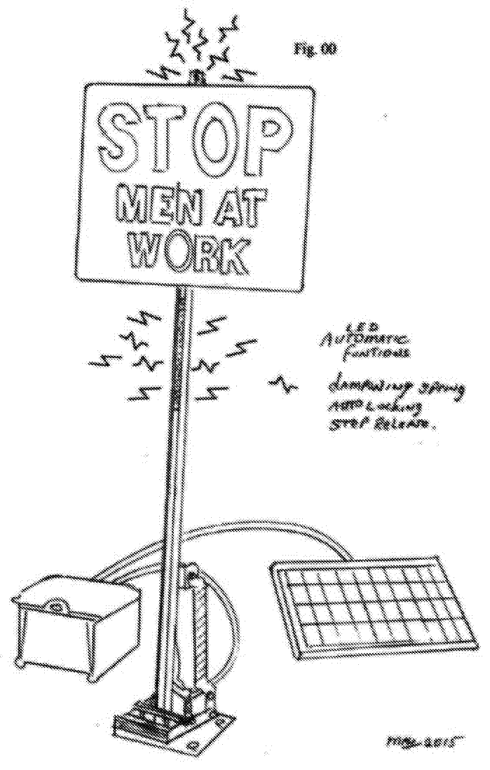

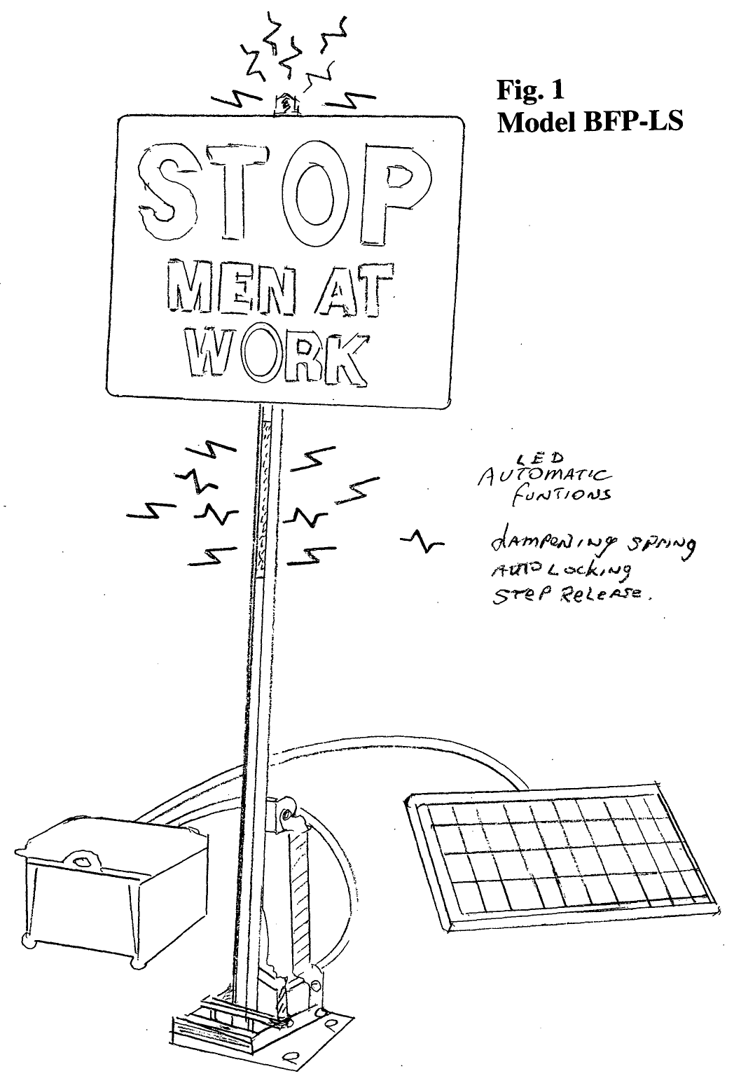

### FIG. 00 SAID SIGN POLE SYSTEM

Goal was to create a light durable operator friendly sign pole system to simplify federal state & local safety compliance.

### OVERVIEW

The invention; an auto On Off sign pole system LED light signal and auto locking pole system that does not require the user to bend over and lift the pole vertically or pull the pole up to secure it. Putting the pole down is simplified with a foot release switch and a dampening feature that assist in being placed in the down position preventing damage to the sign or light fixture as they do not slam to the ground, also LED's are protected within the pole frame. LED light trip sensitivity is adjustable; this feature is controlled by amount of ambient light and can be adjusted. A very important feature if sign pole system is placed under track lighting that can trigger an off mode during night hours. It's an adjustment to correct for this problem.

Unique feature listed items 01/06 with supported Figures views i.e. sign pole system.

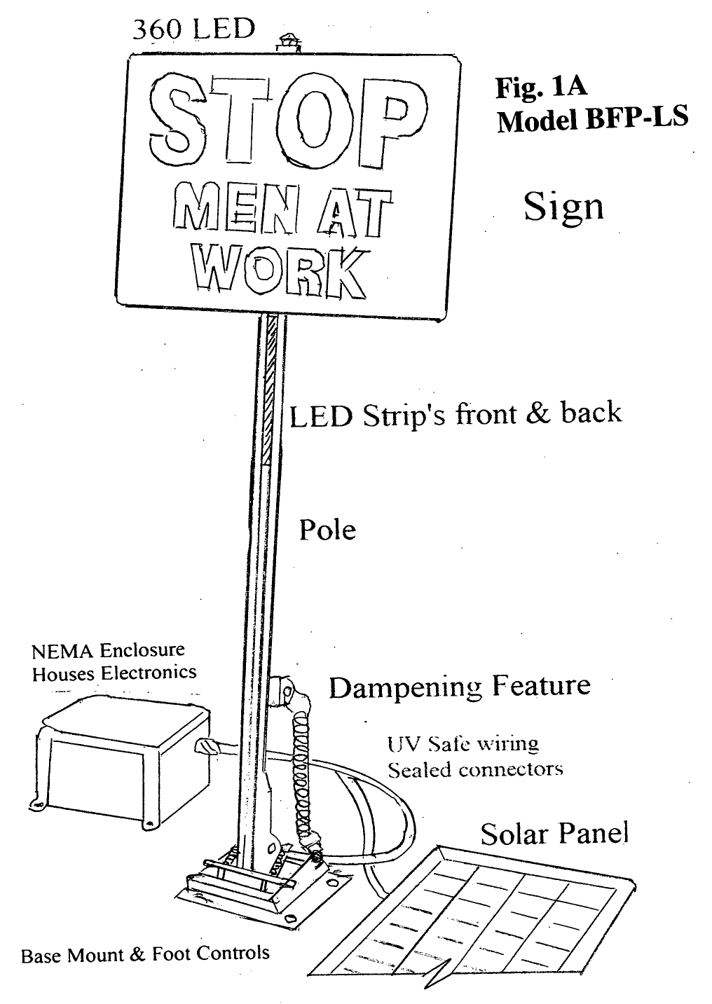

01, FIG. 01

Automatic LED Display Dampened Foot Released Pole Systems

01A, FIGS. 01 & 02

One LED on the top of the pole with 360 degree visibility.

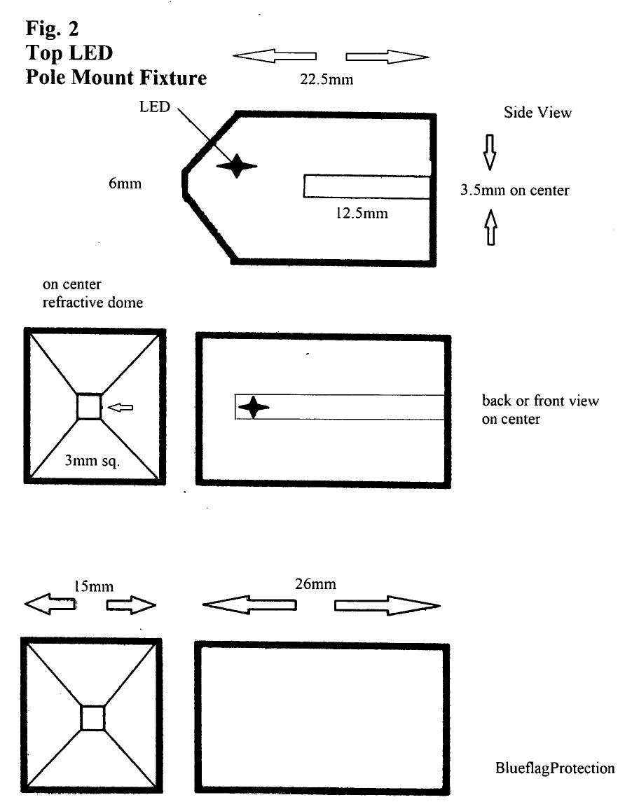

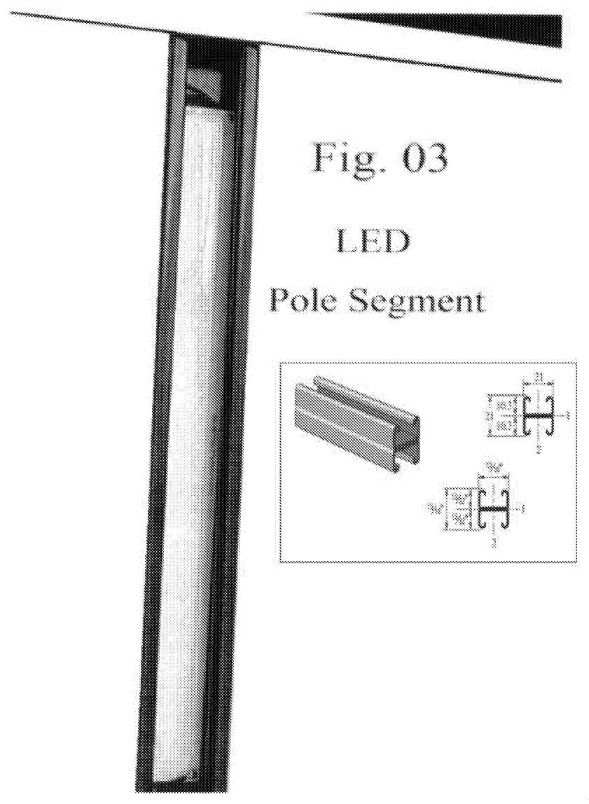

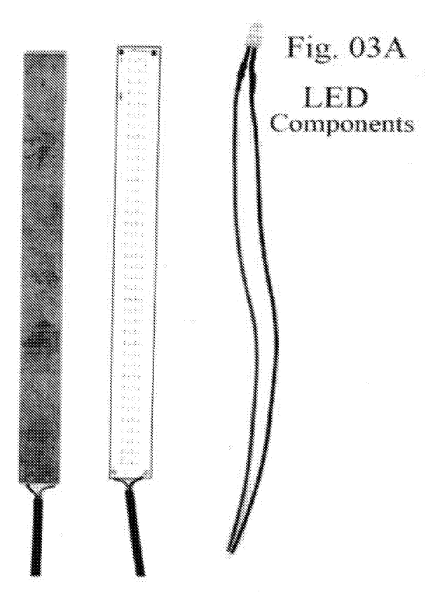

01B, FIGS. 01, 03 & 03A

One LED strip facing forward, One LED strip facing backwards to the rear LED's protected within the frame of the pole.

02, FIG. 01

If it is daylight the Blue LED lighting will remain off. Auto Feature

02A, FIG. 01

If it is daylight the pole sign “Men at Work” or “Safety First” are visible LED's do not need to be on.

02B, FIGS. 01 & 04

If it is night no sunlight and the pole is in the upward position the auto feature will turn on the LED's

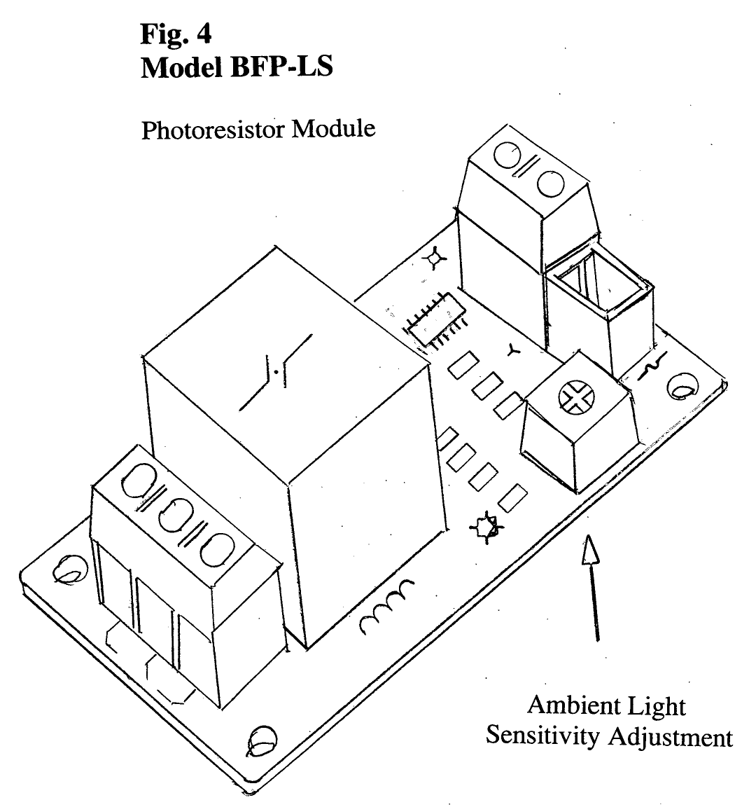

02C, FIG. 04

If it is night, no sunlight and the pole is in the upward position the auto feature light sensitivity trip on point can be adjusted to compensate for over head track lighting. Preventing false trip states do to overhead night lighting.

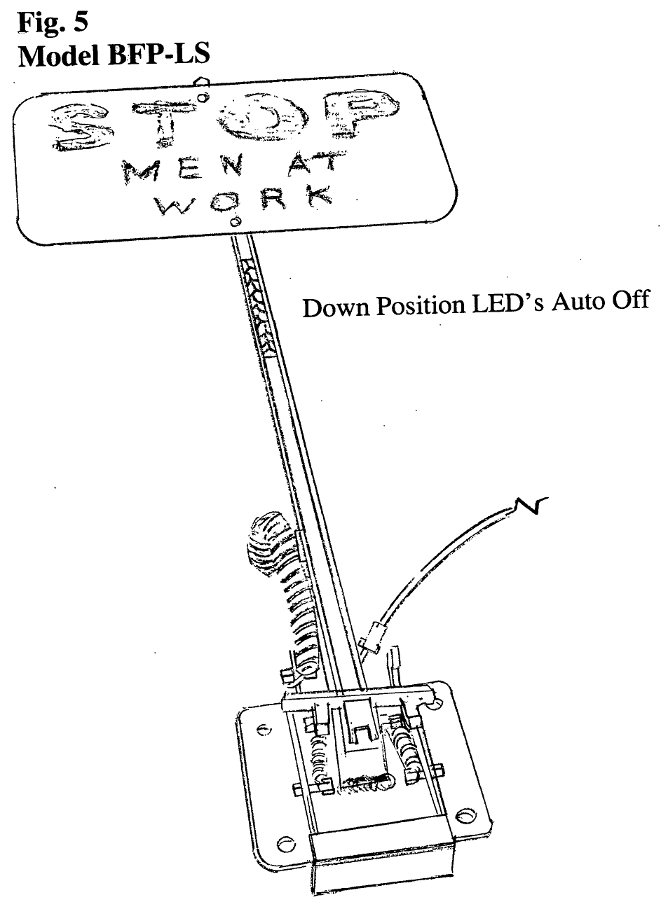

02D, FIG. 05

If it is night no sunlight and the pole is in the down position the auto feature will prevent the LED's from illuminating. LED's remain off.

02E, FIGS. 04 & 06

Pole in the down position day or night power to the photo resistor circuitry is disabled maximizing power to the battery charging controller

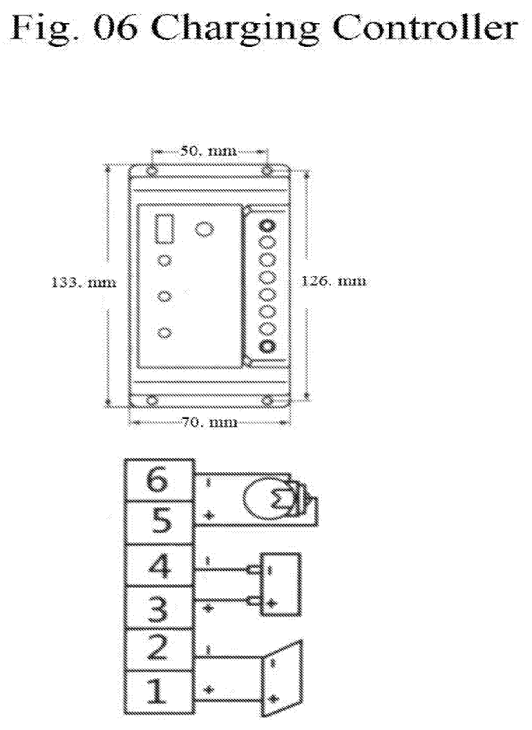

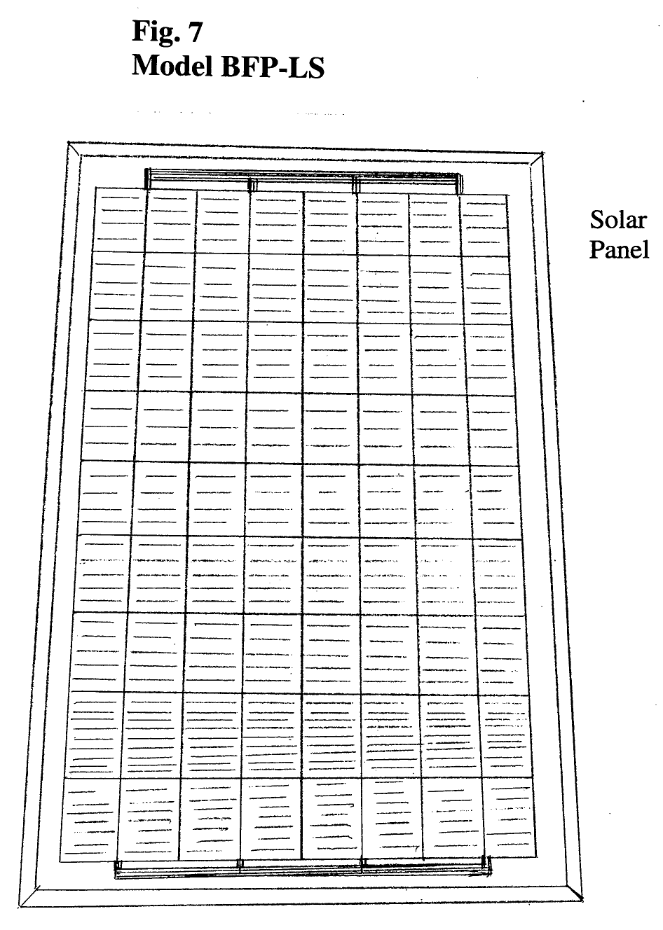

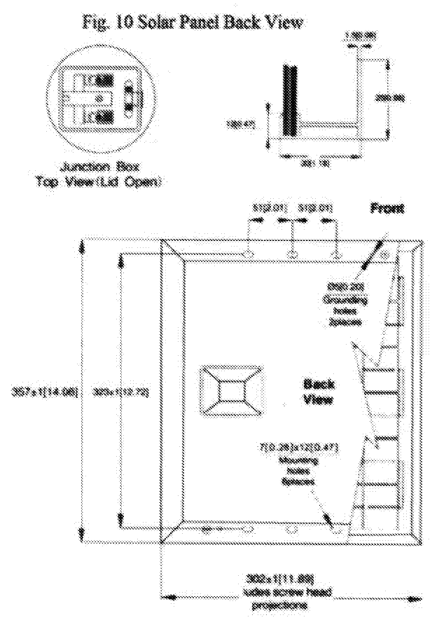

03, FIGS. 06, 07, 10 & 12

If it is daylight the solar panel will feed the charging regulating circuit to charge up the battery. All rights to solar panel held by its manufacture.

03A FIG. 05, 06, 12, 15

Battery Rapid Charge: When the pole is in the down position power to the photoresistor module On Off board is disabled resulting in all the solar panels output to be sent to the charging module for maximum charge.

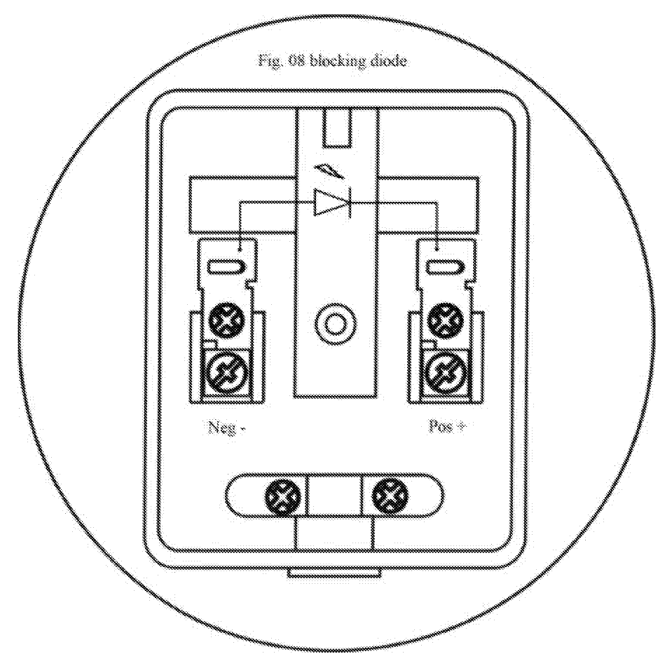

03B, FIG. 08

Solar Panel safety blocking diode, reverse polarity protection.

04, FIGS. 01 & 09

Sealed UL, NEMA Enclosure environmentally seals components from elements.

It houses Electronics, photoresistor relay control module, battery charge regulator and Battery.

NEMA Enclosure manufactured rights belong to Kraloy JBox

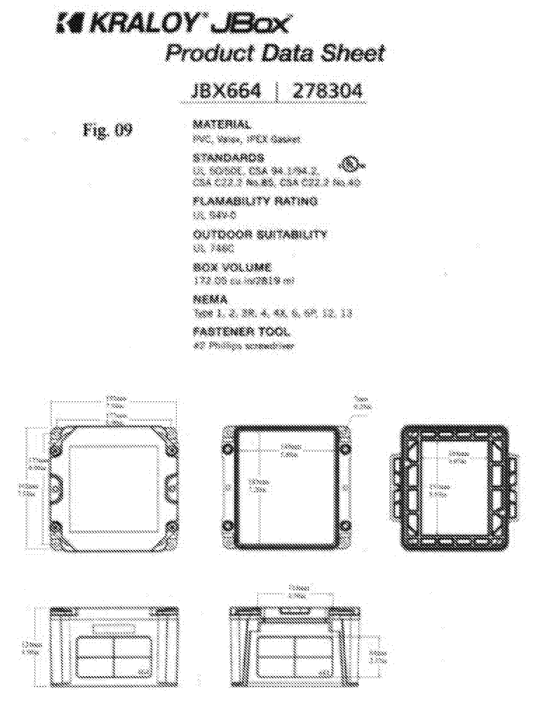

04A, FIG. 09

Enclosure box is lockable or sealable 7 mm. whole diameter can be enlarged

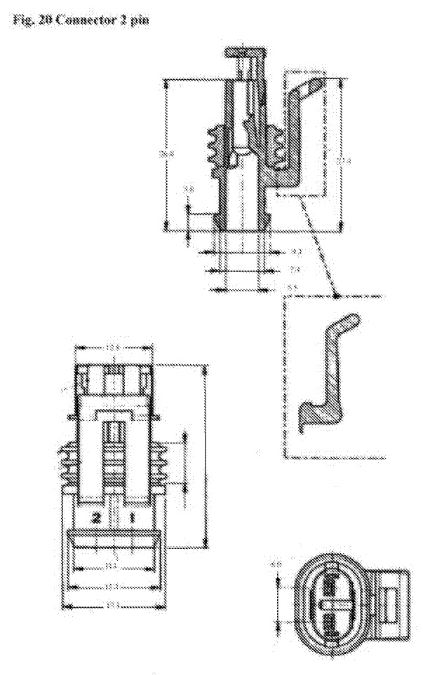

04B, FIGS. 19 & 20

Environmentally sealed connectors, All rights held by manufacture.

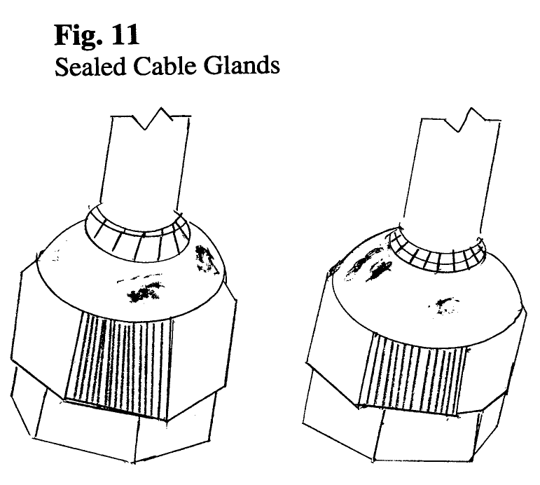

04C, FIG. 11

Environmentally sealed Cable Glands, All rights held by manufacture.

04D, FIG. 01

UV ultra violet safe cabling

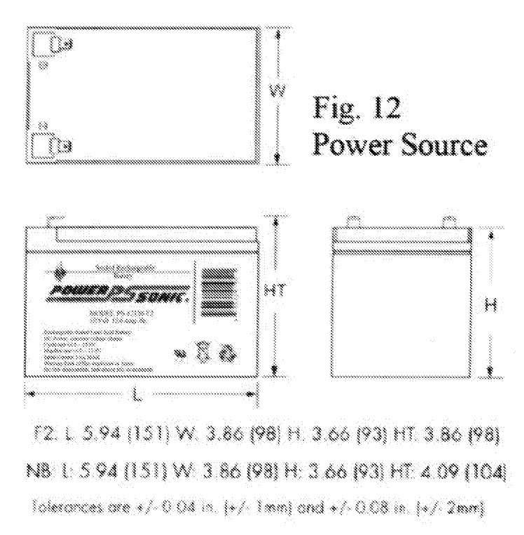

04E, FIG. 12

Rechargeable maintenance free power source Eliminates replacement disposable batteries. All rights held by manufacture.

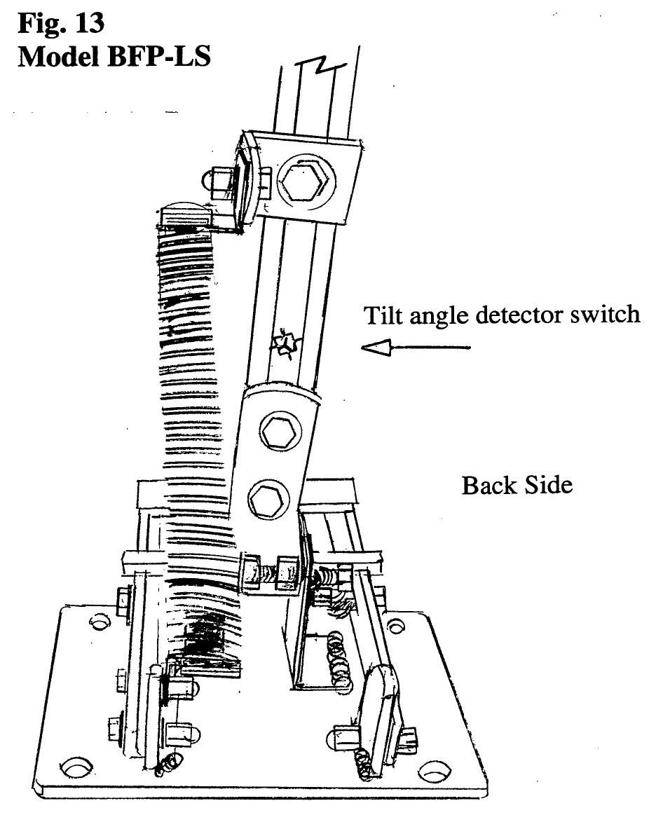

05, FIG. 13

Pole features

Raising or lowering pole is assisted with a built in dampening spring.

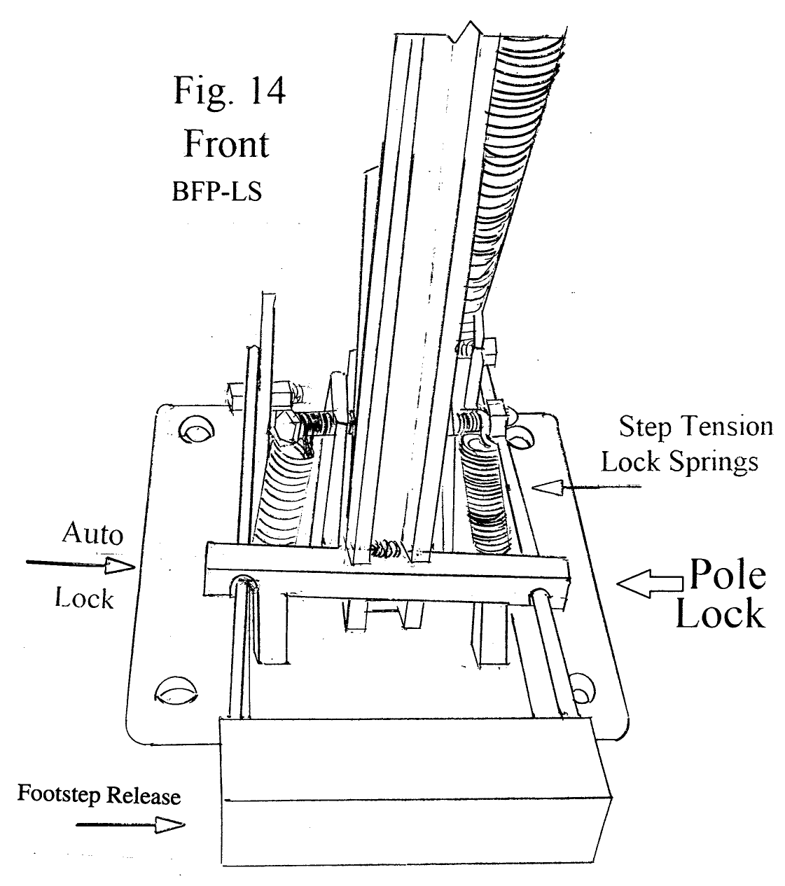

05A, FIG. 14

To release the pole lock to enable it to be lowered simply step down on the foot switch

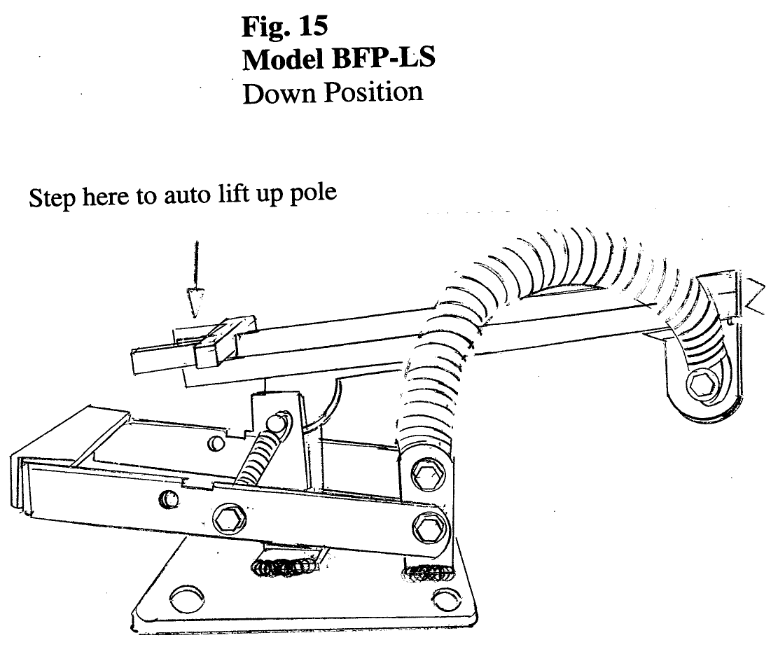

05B, FIG. 15

To lift up the pole simply step down on the base of the pole above the foot switch and pull pole back until it auto locks into place.

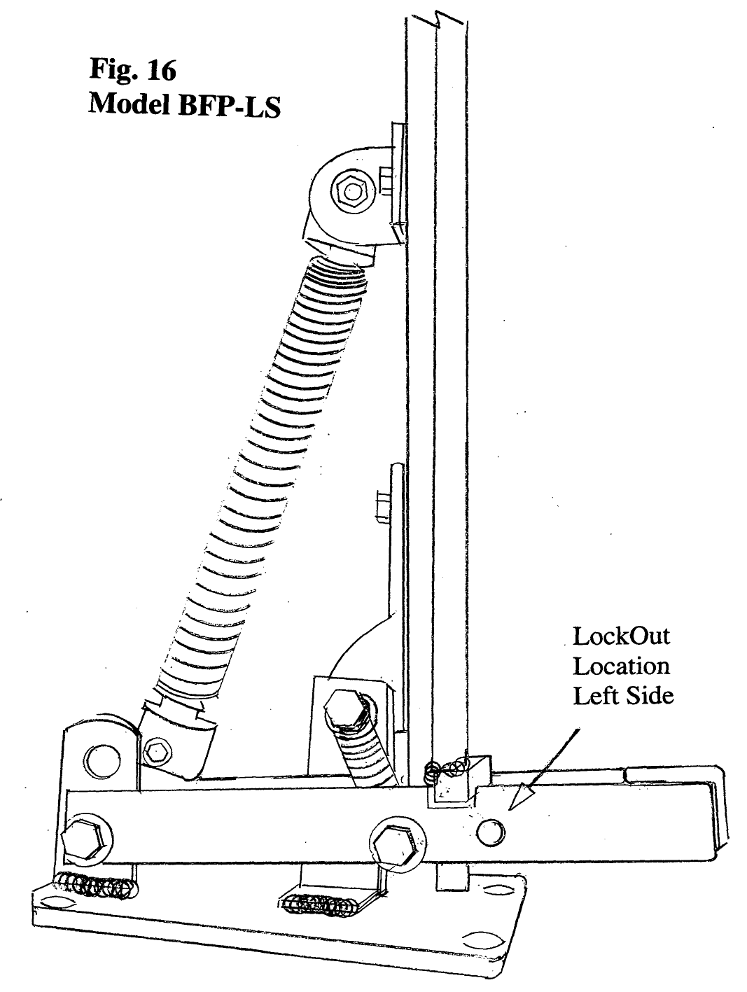

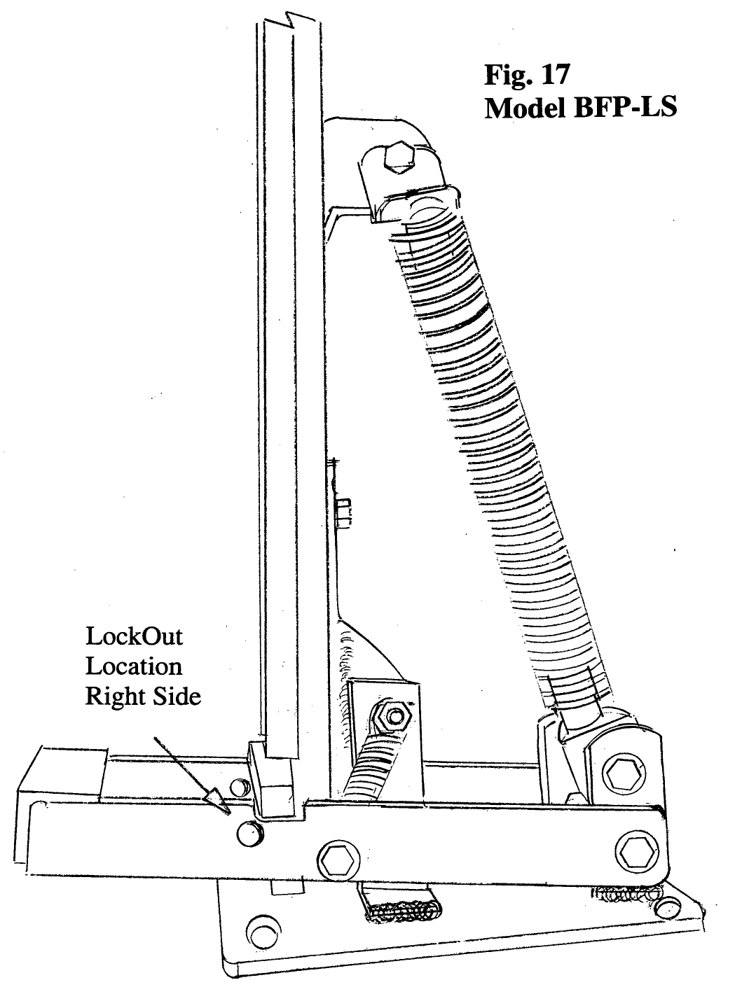

05C, FIGS. 16 & 17

Built in Lockout Tag Out safety feature, when pole is in the up position to protect, indicate work is being preformed pole can accommodate two pad locks or multi person lockout tags located on the swing arm of the foot release step.

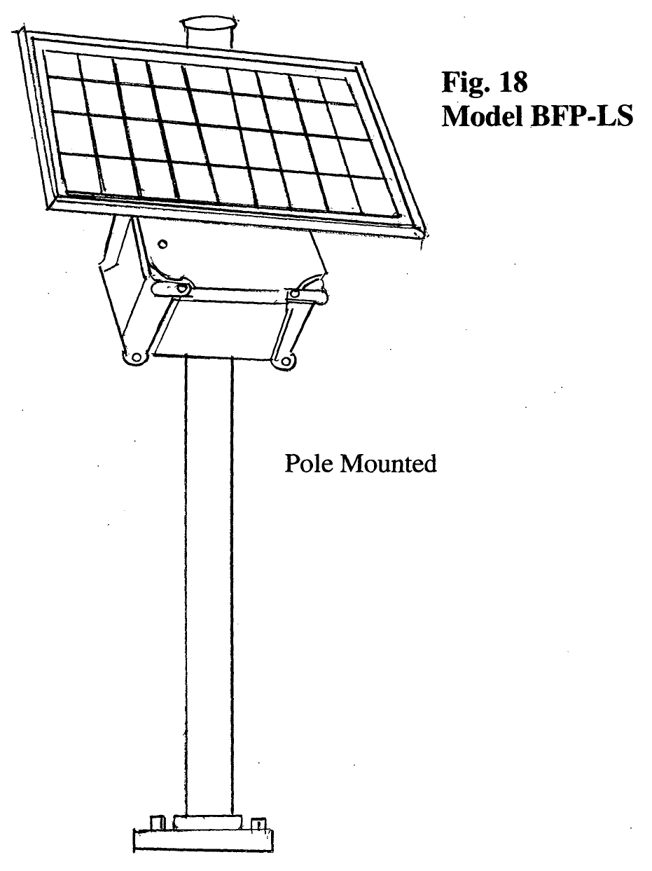

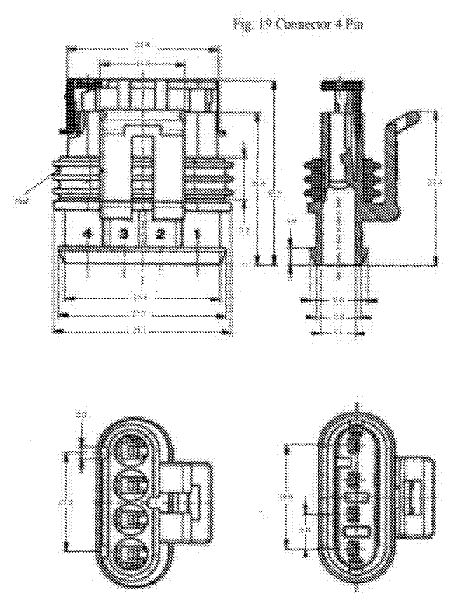

06, FIG. 18

Solar Panel and controller are flat ground mounted for warmer climates, may require an optional pole mount for snow or building obstruction.

1, Automatic LED Display Dampened Foot Released Sign Pole System(s). Comprising:
A, a foot activated locking release said sign pole system.
B, a pole dampening feature assists when pole is being lowered or raised, said sign pole system.
C, an auto up footstep feature to lift pole to vertical position, the operator is not required to bend over and lift the pole vertically to secure it said sign pole system.
D, a LED indicators recessed protected, mounted within the pole channel structure facing forward, back & 360 deg on top, colors clear, red, yellow, blue, ice blue but not limited to said pole system.
E, an auto detect LED pole position, example Vertical/Horizontal eliminates need for on/off switch said sing pole system.
F, an auto day or night status preventing LED indicators from turning on while in the vertical position if daylight said sign pole system.
G, a top mounting area for a sign, Men at Work, Safety First, etc. said sign pole system.
H, a sealed external box enclosure ground or pole mount housing electronics and power source, said sign pole system.
I, a solar panel, said sign pole system.
J, a night time light sensitivity manual adjust, compensates for yard night lighting, Said enclosure sign pole system.
